(19) United States
(12) Patent Application Publication
(10) Pub. No.: US 2007/0033633 A1
(43) Pub. Date: Feb. 8, 2007

(54) Method and apparatus for providing a transition between multimedia content

(75) Inventors: Paul Andrews, Titusville, NJ (US); Jesse Samuel Lerman, Cranbury, NJ (US); James Martin Fredrickson, Princeton, NJ (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Princeton Server Group, Inc., Princeton, NJ (US)

(21) Appl. No.: 11/501,219

(22) Filed: Aug. 8, 2006

Related U.S. Application Data
(60) Provisional application No. 60/706,385, filed on Aug. 8, 2005.

(51) Int. Cl. H04N 9/74; H04N 5/445; H04N 7/16; G06F 3/00; G06F 17/00; G06F 9/00; G06F 13/00

(52) U.S. Cl. 725/135; 348/563; 725/42; 715/751; 348/586

(57) ABSTRACT

A method and apparatus for providing a transition between multimedia content, e.g., video clips. The method and apparatus detects a transition trigger that identifies that a transition is necessary at a specific point within a currently playing video clip. The method and apparatus select a driver level API for producing a desired transition effect, then executes the selected API to produce the transition effect. The transition API controls a video decoder such that a currently playing video can be altered at the transition point to have a specific transition effect. Controlling the luminance and audio signal levels of the decoder creates the desired transition effect.

### CROSS-REFERENCE TO RELATED APPLICATIONS

This application claims benefit of U.S. provisional patent application Ser. No. 60/706,385, filed Aug. 8, 2005, which is herein incorporated by reference.

### BACKGROUND OF THE INVENTION

1. Field of the Invention

Embodiments of the present invention generally relate to systems for broadcasting multimedia content to users through a broadcast channel and, more particularly, to a method and apparatus for providing a transition between multimedia content.

2. Description of the Related Art

To supply continuous programming to viewers (users), content servers (also referred to as video servers) broadcast individual multimedia clips in a sequential manner. As one clip ends, another is begun. An abrupt change between clips causes creates undesirable transitions in the viewing experience. The viewing can be enhanced with controlled transitions between the clips using such techniques as fades, wipes, slides, and more. Transition effects can be used to either enhance the look and feel of a channel, or even to cover up artifacts that are generated from the process of splicing digital multimedia clips to one another. To utilize controlled transitions, predefining splice points can provide a priori knowledge of ideal splicing locations within a clip such that a smooth transition from one clip to another can be produced. However, predefining such splice points requires cumbersome preconditioning and analysis of the clips, and often requires knowledge of playout order of the clips in advance. Knowing the playout order is limiting from a programming standpoint.

Thus, there is a need in the art for techniques for providing transition effects using a digital multimedia server such that multimedia clips do not need to be preconditioned to enhance the end-user experience.

### SUMMARY OF THE INVENTION

The present invention is a method and apparatus for providing a transition between multimedia content, e.g., video clips. The method and apparatus detects a transition trigger that identifies that a transition is necessary at a specific point within a currently playing video clip. The method and apparatus select a driver level API for producing a desired transition effect, then executes the selected API to produce the transition effect. The transition API controls a video decoder such that a currently playing video can be altered at the transition point to have a specific transition effect. Controlling the luminance and audio signal levels of the decoder creates the desired transition effect. In another embodiment of the invention, a transition file may be spliced to a currently playing video at an appropriate time utilizing the transition API to control the transition from the playing video to the transition file. In another embodiment of the invention, graphical overlays are added by controlling an on-screen display function of the decoder. In this manner various graphics can be overlaid upon the video imagery. Once the video has been altered, spliced and/or overlaid, the video containing the transition effect is transmitted as is, for example, an analog signal, or compressed to produce a video stream for transmission. The transmitted video stream, when decoded and displayed by a user's equipment, displays the video imagery including a smooth transition at the appropriate time within the video.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system capable of providing transitions within the video being played;

FIG. 2 is a flow diagram of a method of operation for a broadcast controller in accordance with one embodiment of the invention;

FIG. 3 is flow diagram of a method of operation for a transition controller in accordance with one embodiment of the invention; and

FIG. 4 is a flow diagram of a method of producing a transition in accordance with one embodiment of the invention.

### DETAILED DESCRIPTION

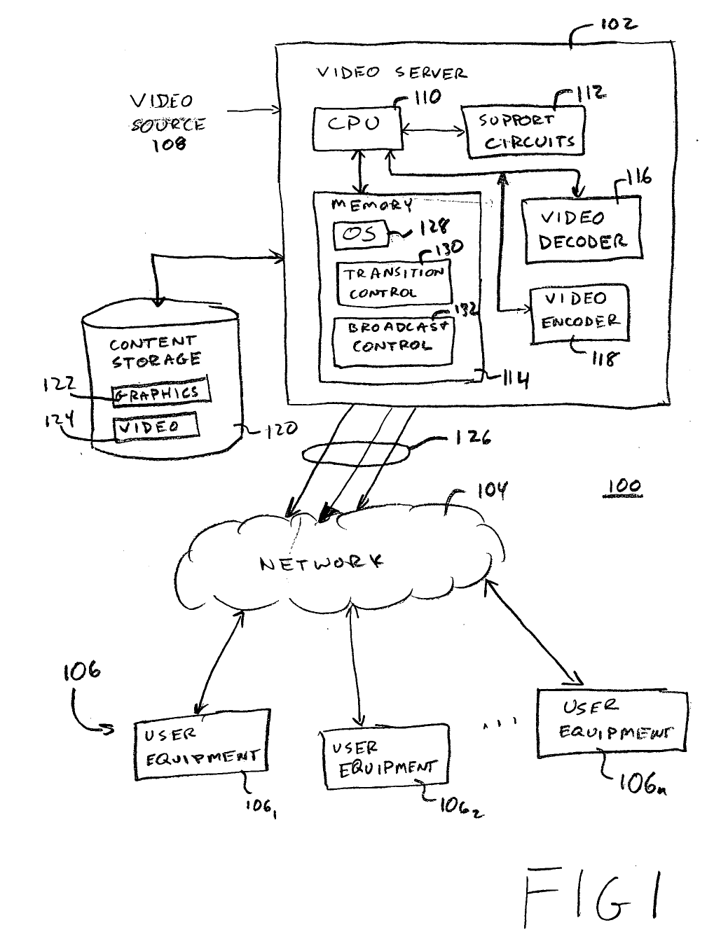

FIG. 1 depicts a block diagram of a system 100 for broadcasting multimedia content, e.g., video., on at least one channel to be viewed by users. The system 100 comprises a multimedia content server 102, content storage 120, a network 104, and user equipment 106₁, 106₂ . . . 106n (collectively referred to as user equipment 106). The content server 102 schedules and organizes program transmissions that are continuously delivered on at least one broadcast channel 126 for viewing by the users on their user equipment 106. In accordance with the present invention, the content server 102 receives video as a compressed stream from video source 108 and at particular times within the video stream the content server applies specific transition effects to transition to other video streams as well as other forms of content. In accordance with the invention, these transitions are created using synthetic effects.

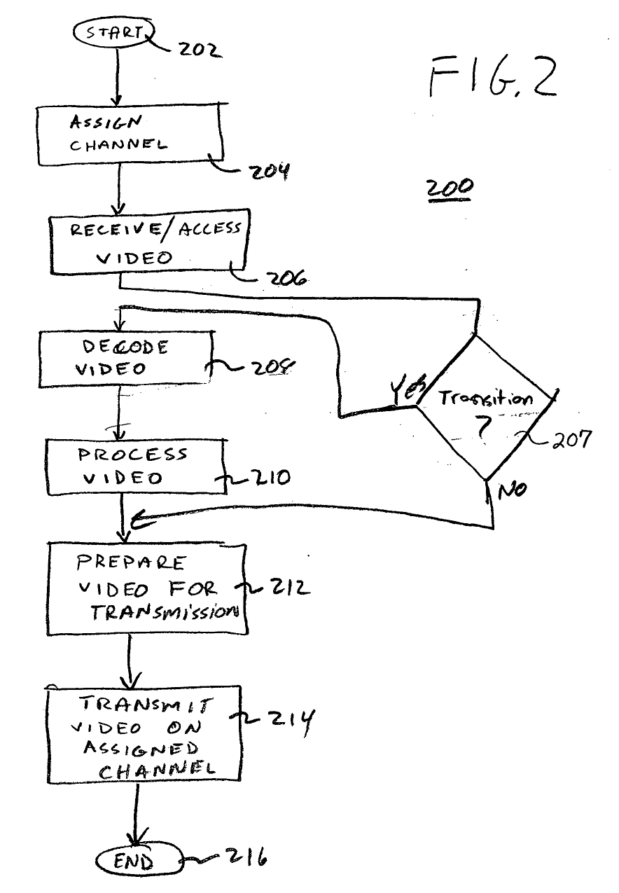

The content server 102 comprises a central processing unit (CPU) 110, support circuits 112, and memory 114. The central processing unit 110 may comprise one or more commercially available microprocessors or microcontrollers. The support circuits 112 are designed to support the operation of the CPU 110 and facilitate the delivery of content to the broadcast channels 126. The support circuits 112 comprise such well-known circuits as cache, power supplies, clock circuits, input/output circuitry, network interface cards, quadrature amplitude modulation (QAM) modulators, content buffers, storage interface cards, and the like. The memory 114 may be any one of a number of digital storage memories used to provide executable software and data to the CPU 110. Such memory includes random access memory, read-only memory, disk drive memory, removable storage, optical storage, and the like. The memory 114 comprises an operating system 128, a transition control module 130, and a broadcast control module 132. The OS 128 may be any one of the operating systems available including Microsoft WINDOWS, LINUX, AS400, OSX, and the like. The other modules operate to provide programming having synthetic effects used to create transitions between video clips in accordance with the present invention. Each of the executable software modules are discussed in detail below with respect to FIGS. 2, 3 and 4.

This server 102 further comprises a video decoder 116 and a video encoder 118. The video decoder is used for decoding the video source content from video source 108. The video decoder 116 may be a commercially available product such as Vela's Cineview family of MPEG decoder PCI cards. Once decoded, the imagery is processed by the content server 102 to create transitions between video clips. The imagery with the transition is then coupled to the broadcast channels 126, and optionally encoded to do so. Since, typically, the broadcast channels 126 and the network 104 are digital, the video, once processed, is re-encoded using the video encoder 118 and modulated using at least one modulator before broadcast on the channels 126. The encoding and modulation processes are well-known in the art.

The server 102 is coupled to a content storage unit 120, which may be any form of bulk digital storage and/or analog storage for storing multimedia content. The content storage 120 stores, for example, graphics 122 and various video clips 124. The server 102 accesses the content from the content storage 120 and, in one embodiment of the invention, uses the accessed content to enhance the transition effect. Programming is organized and transmitted by the broadcast control module 132. The broadcast control module 132 streams the content until a transition trigger is detected that launches the transition control module 130. The transition control module 130 processes the source video and utilizes either additional graphics, video, or specific transition effects to facilitate a transition from the currently playing content (video). In addition to the stored content, the content server 102 may accept a live content feed from the video source 108 and transmit the information via the channels 126 at appropriate times. The live feed may be an analog feed that is converted into a digital signal, or the live feed may be a digital feed that is coupled to one or more channels. The digital feed, to facilitate transition generation, will be provided to the video decoder 116 to facilitate decoding at least a portion of the digital stream to create the transition effects.

The channels 126 propagate the content produced by the content server 102 through the network 104 to user equipment 106₁, 106₂ . . . 106n. In a broadcast configuration, the channels 126 are coupled to one or more of the user equipment 106 such that the user can view the content on their television or computer monitor. The user equipment 106 may comprise a set-top box for decoding the information supplied by the server. To facilitate viewing of the content, the set-top box may be coupled to a television or other display unit. Alternatively, the user equipment 106 may be a computer that is capable of decoding the video content and displaying the information to the user. In either case the synthetic transition effects that are provided in accordance with the invention are viewable on the user equipment to provide a pleasing and enjoyable experience to the user.

In one embodiment of the invention, the server 102 is used to broadcast information to the users in a unidirectional manner through the channels 126, through the network 134, to the user equipment 106. The user equipment 106 selects a channel to decode and view. Such a broadcast may use multicast IP addresses that can be tuned by the user equipment 106 to select programming for viewing.

In another embodiment of the invention, the user equipment 106 may request particular information, such as in a video-on-demand (VOD) type system or a browser-based system. A back channel may be provided (not shown) for requesting specific video or other content to be delivered to the user equipment 106 via the channels 126. In this embodiment, the broadcast control module 132 will accept the request, then access the requested content and deliver that content on a specific channel and/or using a specific IP address to the user equipment 106.

To create the synthetic transition effects in accordance with the present invention, the broadcast control module 132 interacts with the transition control module 130 to control the video decoder 116. By controlling the video decoder at appropriate times, the video supplied from video source 108 can be processed to include specific transition effects such as fade, swipe, and the like. In addition, certain graphics and video clips may be incorporated into the transition to provide additional transition effects.

In one embodiment of the invention, the synthetic effects technique, as the transition point is reached, the transition control module can display a solid black image (or other image such as station identifier or channel identifier) and change the transparency level from transparent to opaque, and then opaque to transparent such that the overlay is opaque during the time any artifacts within the transmission may be seen. Different algorithms for the rate of change of the transparency during the effect may be employed including linear or logarithmic changes. This effect is created by controlling the on-screen display or graphics processing within the video decoder 116 or on a downstream graphics device. These synthetic fades can also be used for transition effects between video and non-video elements and objects such as graphic overlays. For example, the content server may employ a frame buffer for graphic overlays such as a lower third of the screen with dynamic graphics. When the information is updated for the lower third, such as transitioning from a sports ticker to flash animation, the synthetic fade can be used to fade down the first lower third, and then fade up the new lower third information for a seamless transition effect. The video overlay effects can also use synthetic fades to fade up the overlays and fade back down for pleasing transitions on top of the video compared to a simple on and off transition.

A synthetic fade is one embodiment of a synthetic effect using a frame buffer, but other synthetic effects may be implemented such as moving the frame buffer location smoothly across the screen for a “sliding door” type of effect. The frame buffer image can start with a solid black background, slide across the screen to cover the other playing elements, the playing elements can be changed, and then the frame buffer can slide away; thus, providing a sliding door effect.

In another embodiment, for more sophisticated transition that require blending or processing between the two video clips at the transition point, “look ahead” processing can be employed in cases where the real-time processing is not possible. For example, transitions between high-definition video clips in real time might require more processing than a cost effective content server platform has available. In “look ahead” processing the content server knows the playlist, schedule, or transition clips in advance so that the content server can process just the area of video required for the effect. Processing would involve decoding a portion of the end of clip A and a portion of the beginning of clip B, performing image processing and then recoding the transition clip. Since the processing is done in advance, the content server can also find appropriate splice points to cut the end of clip A, and the beginning of clip B. The steps are as follows: Step 1. Find a suitable point at the end of clip A, wherein a suitable out point is defined as the closest exit point prior to or at the section of data required for the desired transition period. Call the sub-clip from this outpoint to the end of clip A to be A_{T} and the rest of the clip to be A_{C}. Step 2. Find a suitable start point at the beginning of clip B, wherein suitable start point is defined as the closest entry point after the section of data required for the transition effect. Call this sub-clip from this point to the start of B to be B_{T} and the rest of the clip B_{C}. Step 3. Decode A_{T} and B_{T} and apply image processing such as wide, fade, or any other transition effect and call this new clip T. Step 4. Re-encode T so that the transitions between A_{C} and B_{C}. Step 5. When the transition is ready to play, the clip sequence actually played is A_{C} then T then B_{C}. This form of partial decoding of an encoded video stream adding a transition clip and then re-encoding the clips is well-known in the art.

FIG. 2 depicts a flow diagram of a method 200 of operation of the broadcast control module 132. The method 200 begins at step 202 and proceeds to step 204, where at least one channel is assigned for the incoming video stream that is scheduled to be broadcast. At step 206, the content server either receives a video sequence from the video source 108 or accesses the video clip from content storage 120. At step 208, the video is decoded within the video decoder 116. At step 210, the video is processed. At step 207, the method 200 queries whether a transition is upcoming. If a transition is upcoming, then at the appropriate time for when the transition is to occur, the video is sent to the video decoder to be decoded at step 208. In one embodiment of the invention, the module knows when the data representing an end to the currently playing video clip has been transferred to an output buffer. Once the end is recognized a transition is launched. The knowledge of a clip ending may also be based upon a schedule, an exit marker, a timestamp within the compressed video file and the like. For example, the server may use such knowledge to identify when one second of clip remains and start a transition at that point.

At step 210, the video is processed to provide a proper transition that is desired for that particular video. If a transition is not indicated or triggered at step 207, then the method 200 proceeds to step 212 where the video is prepared for transmission. In this step, the packets may be addressed using either a multicast IP address or specific IP address of a user's equipment. Alternatively, the video may be an analog, SDI, HD-SDI and the like, where the signal is broadcast over non-addressable channels. At step 214, the video is transmitted on an assigned channel to the network 104. Within the network 104 there may be a cable head end that receives the content. The head end may then distribute the content to the users. The method 200 ends at step 216.

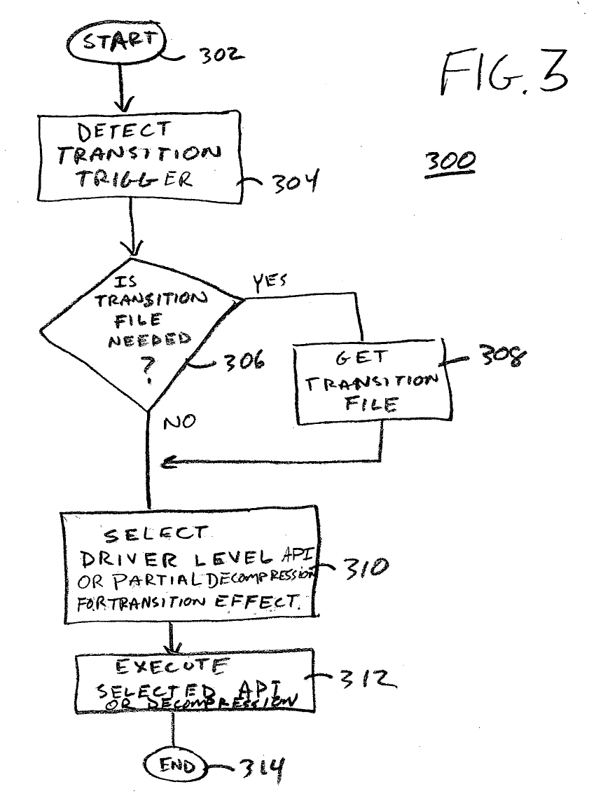

FIG. 3 depicts a flow diagram of a method 300 of operation of the transition control module 130. This module is launched when a transition trigger is detected in step 207 of FIG. 2. This method is utilized during the video decoding step 208 and the processing step 210.

The method 300 starts at step 302 and proceeds to step 304. At step 304, the method 300 detects the transition trigger that caused the launch of the transition control module. The transition trigger contains information that indicates what sort of transition is to be performed. This transition trigger may contain metadata and other information that identifies whether the transition is to be a fade, a swipe, contain graphics, utilize a transition file containing video, and the like.

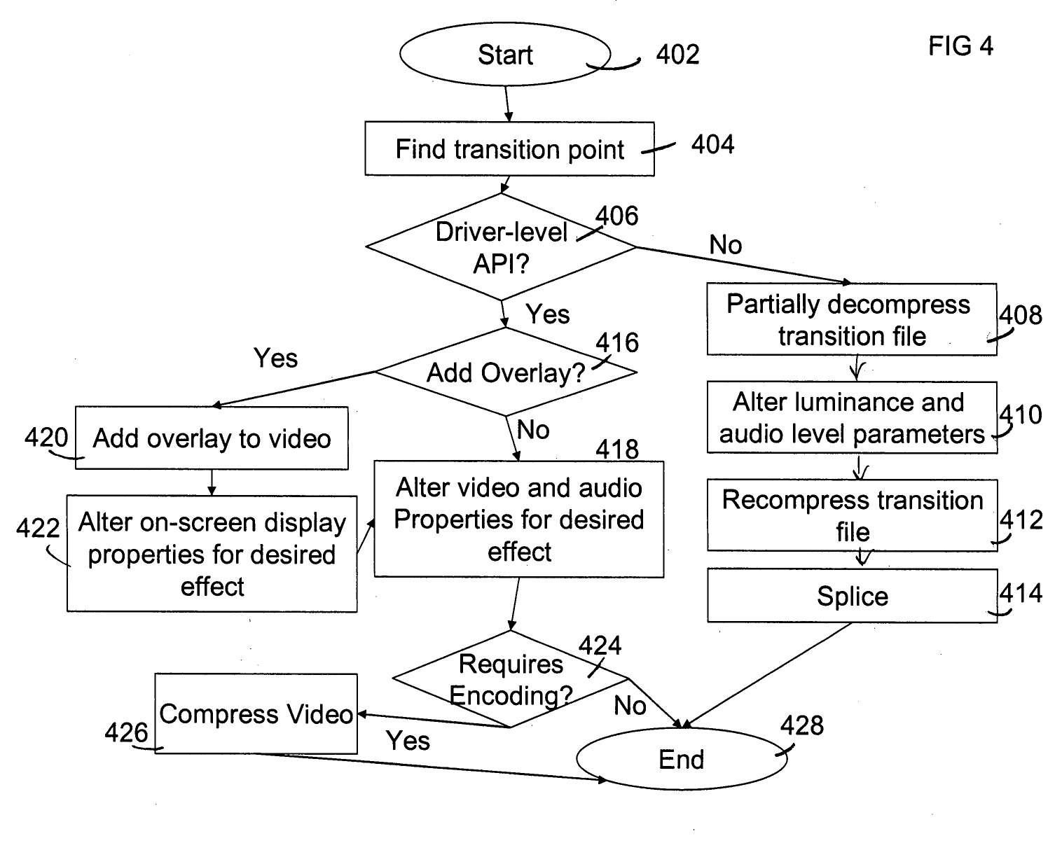

At step 306, the method 300 queries whether a transition file is needed to perform the desired transition. If a transition file is necessary then, at step 308, the method 300 retrieves a transition file from the content storage 120. This transition file may be a video clip that will be used as the transition, it may be specific graphics that are going to be used within the transition, or the file may contain a combination of graphics and video. If a transition file is not necessary or after the transition file is retrieved, the method 300 proceeds to step 310. At step 310, the method 300 selects a driver-level API or a portion of the multimedia clip to partially decode (decompress) to facilitate the desired transition effect. The operation for such an API is discussed in more detail with respect to FIG. 4. If partial decompression is used, a portion of the clip is decoded to facilitate alteration of certain data bits within the clip to produce the desired transition effect. At step 312, the method 300 executes the selected API to cause the transition effect to occur or decodes the appropriate portion of the clip to facilitate the transition effect. At step 314, the method 300 ends and returns to the broadcast control module as discussed with respect to FIG. 2.

FIG. 4 depicts a flow diagram of a method 400 of operation of a driver-level API or partial decompression in accordance with one embodiment of the present invention, i.e. steps 310 and 312 of FIG. 3. The method 400 begins at step 402 and proceeds to step 404, where a transition point is found within the video stream. The transition point may be identified by the timestamp in the compressed video that corresponds to a certain amount of time remaining that matches the desired transition time. Alternatively, the transition point may be close to the end of the video stream such as when the last data for the stream has been written to the output buffer. In either case, at step 404, the method 400 determines the transition point within the stream. At step 406, the transition technique is selected based on whether a driver-level API is available. If a driver-level API is not available, such as may be the case for a DVB-ASI or IP video server that transmits compressed signals without normally decompressing, the method continues to step 408.

At step 408, the transition point onward to the transition end point is partially decompressed to expose the data bits that describe video and audio properties including luminance and audio level. At step 410, the luminance and audio levels are altered to produce the desired effect such as a fade down and fade up. At step 412, the resulting transition clip is recompressed and at step 414 the transition clip is played or spliced into the stream. At step 428, the transition is complete and the stream is delivered to the channel. If the partial decompression process is not executed in real-time, the process of creating the transition clip may be done in advance of reaching the actual transition point 404.

If a driver-level API does exists at step 406, such as would typically be the case for an analog, SDI, or HD-SDI video server that decodes compressed video, the method continues to step 416. At step 416, the method may optionally add an overlay to create or assist with the transition effect. If no overlay is added, the method continues to step 418. At step 418, the video and/or audio control property levels of the video decoder 116 are adjusted to create a specific transition effect. These properties include for example, brightness, audio volume and the like. This effect may comprise a fade, a swipe, and audio information may be faded or deleted to remove the sound, and the like.

In a practical situation, consideration is given to when to fade up/down in view of the decoder presentation delay. When a clip is written to the decoder, some amount of time (typically 1 GOP (Group Of Pictures) time (˜0.5 secs)) is required before the image is actually displayed. As such, the fade up procedure is invoked 0.5 secs after a clip is initiated. Fade down is a little less predictable. When the last bit of data is written to the decoder, it is unknown exactly how much of the data has been internally buffered by the device at that time (typically 1 GOP but not necessarily). The length of the delay depends upon the content bitrate and whether it is CBR or VBR can vary the final presentation delay to any significant extent. Analysis of the MPEG bit stream itself to determine the total playout time may be used to determine when to begin the fade down procedure. In one embodiment of the invention, the fade up/down is achieved by raising/lowering the brightness, blacklevel, contrast, saturation and volume of the decoder device (Note: if any one of these achieved total blackness by itself, only that parameter need be manipulated.

The following is pseudocode for one embodiment of the inventive transition technique:

```
playout(file)
{
  startMsec = 0;
  totalMsec = getDuration(file);
  while ((n = read(file, buffer, sizeof(buffer))) > 0) {
    write(device, buffer, n);
    if (!startMsec) {
      startMsec = currTime( );
    } else {
      if (!fadedUp) {
        if ((currTime( ) − startMsec) > 500) {
          initiateFadeUp(device);
          fadedUp = YES;
        }
      }
    }
  }
  endTime = startTime + totalMsec;
  timeNow = currTime( );
  if (endTime > timeNow) sleep(endTime − timeNow);
  initiateFadeDown(device);
  fadedUp = NO;
}
```

If at step 416 an overlay is to be added, the method 400 proceeds to step 418, where the method 400 where the overlay is generated using the on-screen display graphics and/or an alpha blend technique that will blend specific graphics from a transition file into the video and/or video with a transition file attached. The method continues to step 422 where the overlay properties can be altered to produce a desired effect such as a fade by altering the overlay alpha blend value or a sliding door by altering the overlay position. Optionally, the method 400 may combine with the overlay-generated effect a driver-level API effect of step 418.

The following is exemplary pseudocode for a method of using and OSD overlay to create a fade up/down:

```
display_black_overlay_fully_transparent
alpha = 0
while i<=255:
  set_alpha(alpha)
  time.sleep(down_transition_time/num_steps)
  alpha = alpha + 255/num_steps
while i>=0:
  set_alpha(alpha)
  time.sleep(up_transition_time/num_steps)
  alpha = alpha − 255/num_steps
```

Assumes alpha=0 for fully transparent
Assumes alpha=255 for fully opaque
Linear example, could be logarithmic etc . . . .

The following is exemplary pseudocode for a method of using and OSD overlay to create a sliding door tranistion:

```
display_black_overlay_offscreen_to_far_left
x_position = −480
while x<=0:
  set_x_position(x)
  time.sleep(down_transition_time/num_steps)
  x = x + 480/num_steps
while x>=−480:
  set_x_position(x)
  time.sleep(up_transition_time/num_steps)
  x = x − 480/num_steps
```

Assumes screen width is 480 pixels
Assumes x position 0 for a black 720×480 overlay covers the screen
Linear example, could be logarithmic etc . . . .

At step 424, the method determines whether the processed video with the transitions and the overlays, if any, should be recompressed to form a compressed digital video stream for transmission, for example over a DVB-ASI or IP channel. If so, the method continues to step 426 to compress the signal.

At step 428, the method 400 ends and returns to the transition control module.

Using the technique of the present invention, a transition can be created for multimedia content within a content server. The content and the transition are transmitted from the content server to user equipment such that a viewer is presented with a smooth transition between content clips.

While the foregoing is directed to embodiments of the present invention, other and further embodiments of the invention may be devised without departing from the basic scope thereof, and the scope thereof is determined by the claims that follow.

What is claimed is:

1. A method for creating transitions for multimedia clips, where the method is performed within a multimedia content server, comprising:
providing a multimedia clip to a video decoder within the multimedia content server;
detecting a transition trigger to identify a point in the multimedia clip at which a transition is to be generated; and
controlling the functionality of the video decoder to produce a specific transition effect for the multimedia clip.

2. The method of claim 1 wherein the multimedia clip is a video clip.

3. The method of claim 1 wherein the transition trigger is at least one of a timestamp, an end of file indicator or is contained in metadata associated with the multimedia clip.

4. The method of claim 1 further comprising splicing a transition clip onto the multimedia clip at the specific transition point.

5. The method of claim 1 controlling the functionality of the video decoder to adjust at least one on-screen display graphic to produce an overlay as the transition effect.

6. The method of claim 1 wherein the controlling step further comprises selecting a driver level API for implementing the specific transition effect.

7. The method of claim 6 wherein the driver level API changes at least one of luminance or audio level of the multimedia clip.

8. The method of claim 6 wherein the driver level API produces at least one of a fade, a slide, or a swipe.

9. The method of claim 1 wherein the controlling step further comprises partially decoding the multimedia clip to facilitate altering data bits within the multimedia clip to create the specific transition effect.

10. The method of claim 9 wherein the altered data bits change at least one of luminance or audio levels of the multimedia clip.

11. A server for creating transition for multimedia clips comprising:
a broadcast control module for receiving a multimedia clip and broadcasting the clip via at least one channel;
a transition control module, coupled to the broadcast control module, for controlling a video decoder to create a transition for the multimedia clip.

12. The apparatus of claim 11 wherein the multimedia clip is a video clip.

13. The apparatus of claim 11 wherein the transition control module is activated upon the occurrence of a transition trigger, the transition trigger is at least one of a timestamp, an end of file indicator or is contained in metadata associated with the multimedia clip.

14. The apparatus of claim 11 wherein the video decoder splices a transition clip onto the multimedia clip at the specific transition point.

15. The apparatus of claim 11 the video decoder adjusts at least one on-screen display graphic to produce an overlay as the transition effect.

16. The apparatus of claim 11 wherein the transition control module selects a driver level API for implementing the specific transition effect.

17. The apparatus of claim 16 wherein the driver level API changes at least one of luminance or audio level of the multimedia clip.

18. The apparatus of claim 16 wherein the driver level API produces at least one of a fade, a slide, or a swipe.

19. The apparatus of claim 11 wherein the video decoder partially decodes the multimedia clip to facilitate altering data bits within the multimedia clip to create the specific transition effect.

20. The method of claim 19 wherein the altered data bits change at least one of luminance or audio levels of the multimedia clip.
